(19) United States
(12) Patent Application Publication
(10) Pub. No.: US 2026/0316302 A1
(43) Pub. Date: Oct. 15, 2026

(54) COMPENSATION UNIT FOR AN AUTOMATION PLANT, AND HANDLING DEVICE

(71) Applicant: SCHUNK SE & Co. KG Spanntechnik Greiftechnik Automatisierungstechnik, Lauffen am Neckar (DE)

(72) Inventors: Michael Franz, Ilsfeld (DE); Thomas Feucht, Brackenheim (DE)

(21) Appl. No.: 19/484,774

(22) PCT Filed: Apr. 22, 2024
(86) PCT No.: PCT/EP2024/060870

§ 371 Date: Nov. 14, 2025

(30) Foreign Application Priority Data
May 16, 2023 (DE) 10 2023 112 875.2

(51) Int. Cl. B25J 17/02

(52) U.S. Cl. CPC B25J 17/0233

(57) ABSTRACT

A compensation unit for an automation plant is configured for arrangement between a handling device and a tool. The unit includes a fastening part and a compensation part that is movable relative to the fastening part along an x-axis and along a y-axis extending perpendicularly to the x-axis, from a home position to a compensation position. At least one first guide extending along the x-axis and at least one second guide extending along the y-axis are provided, the first and second guides being arranged in a common guide plane.

### DESCRIPTION

The invention relates to a compensation unit for an automation plant, in particular to be arranged between a handling device and a tool, having a fastening part and having a compensation part, wherein the compensation part is arranged so as to be movable along an x-axis and along a y-axis, extending perpendicularly to the x-axis, with respect to the fastening part from a home position into a compensation position. The compensation direction of the compensation part consists of its movement from the home position along the x-axis and/or along the y-axis. The compensation unit has at least one first linear guide extending along the x-axis for guiding the compensation part along the x-axis and at least one second linear guide extending along the y-axis for guiding the compensation part along the y-axis.

Compensation units, which are also referred to as overload protective apparatuses, are known in the prior art and are used in particular for externally powered handling devices, for example in industrial robots with axis or path control, to avoid damage in the event of collisions between the tool and objects in the surroundings of the handling device. For this purpose, the compensation unit comprises the fastening part intended for arrangement in particular on the handling device, for example on a receiving flange of a robot arm. the compensation part, for example in the form of a tool flange, is provided on the fastening part, which tool flange is designed in particular for receiving handling tools, for example gripping apparatuses, machining apparatuses or measuring apparatuses. The compensation part is movably connected to the fastening part so that a relative movement or compensation movement between the fastening part and the compensation part is possible. In this case, linear compensation movements can be provided depending on the field of application of the handling tools attached to the tool holder.

The applicant's XYZ AGE-S compensating unit, which is shown in current catalog materials, is a known embodiment of a compensating unit for carrying out a compensating movement in the three spatial directions. The compensation part of the AGE-S has two movable planes, with one of the planes being movable in the x-direction and the other in the y-direction in order to make it possible to compensate for the compensation part in the x-direction and y-direction from the home position into the relevant compensation position. Furthermore, compensation in the third spatial direction, in the z-direction, is possible.

DE 10 2015 113 346 A1 discloses a compensation unit with spring pins on a housing part for mounting a compensation element, wherein the spring pins lie in one plane. DE 10 2022 204 759 A1 discloses a compensation device with a pivotable wobble plate and an end effector connection point arranged thereon, which can move in a translational manner.

Compensation devices are known from DE 10 2013 208 635 B4 and DE 10 2021 208 632A1.

The object of the invention is that of providing a compensation unit which is improved in comparison with the prior art and which is in particular lighter and smaller and has a longer service life.

The object addressed by the invention is achieved by a compensation unit having the features of claim 1. The first linear guide and the second linear guide are arranged in a common guide plane.

Within the context of this invention, “arranged in a (common) guide plane” means that the at least one first linear guide and the at least one second linear guide each have a center point and the center points span a guide plane.

The first linear guide preferably only allows translational movement along the x-axis. The second linear guide preferably only allows translational movement along the y-axis. The first linear guide preferably blocks movement transversely to the x-axis. The second linear guide preferably blocks movement transversely to the y-axis. The first and/or second linear guide preferably block(s) a rotational movement of the compensation part and/or the guide frame.

Preferably, the at least one first linear guide and the at least one second linear guide are arranged such that the guide plane extends in parallel with the x-axis and in parallel with the y-axis, i.e., perpendicularly to a z-axis. It is conceivable that a total of at least three linear guides is provided, wherein the at least three guides are arranged in a guide plane. It is further conceivable that a total of at least three linear guides is provided and that these at least three linear guides are arranged in a guide plane running perpendicularly to the z-axis.

The arrangement of the first linear guide and the second linear guide in one guide plane means that, in comparison with the prior art, the compensation unit is flat and more lightweight since two movable planes arranged one above the other are not required. This leads to lower transverse forces and lower moment loads acting on the linear guides and the connecting means. Furthermore, this also results in uniform loading and a uniform wear pattern on the linear guides, since there is no lever arm difference along the z-axis between the center of gravity of the compensation unit and the X linear guide system or the Y linear guide system. This is particularly relevant for robot applications and various handling applications, as the torque load is further increased by the accelerations involved. This allows for a smaller and lighter compensation unit with a longer service life to be provided.

An advantageous development of the invention provides that the compensation unit has a guide frame. Preferably, the compensation part is arranged so as to be movable relative to the fastening part along the x-axis and along the y-axis from the home position into the compensation position by means of the guide frame.

The guide frame is preferably formed separately from the fastening part and/or the compensation part. The guide frame is preferably provided with the at least one first linear guide for guiding the guide frame on the fastening part. The at least one second linear guide is preferably provided on the guide frame for guiding the compensation part on the guide frame. By means of the guide frame, the compensation part can be mounted on the fastening part so as to move along the x-axis and/or the y-axis. The guide frame is preferably arranged along the z-axis between the fastening part and the compensation part. The guide frame preferably extends along the guide plane, wherein in particular the center point and/or the center of gravity of the guide frame is arranged in the guide plane.

Preferably, the compensation unit, in particular the fastening part, has a housing. The housing has a receptacle on the top for receiving the guide frame and/or the compensation part. In the assembled state, the housing forms an at least substantially closed unit together with the compensation part and/or the guide frame. Preferably, the fastening part, in particular the housing, and/or the compensation part have an end stop acting along the x-axis and/or along the y-axis for limiting the movement of the compensation part and/or the guide frame along the x-axis and/or the y-axis from the home position.

It is advantageous if the guide frame is arranged so as to be movable relative to the fastening part along the x-axis. This means that the guide frame can be moved relative to the fastening part from the home position along the x-axis. It is also advantageous if the guide frame is fixedly arranged relative to the fastening part along the y-axis. This means that the guide frame cannot be moved relative to the fastening part from the home position along the y-axis.

Advantageously, the compensation part is arranged so as to be movable relative to the guide frame along the y-axis. This means that the compensation part can be moved relative to the guide frame from the home position along the y-axis.

Furthermore, the compensation part can therefore be freely moved relative to the fastening part along the x-axis and along the y-axis, i.e., in parallel with the guide plane, by means of the guide frame. It is also advantageous if the compensation part is fixedly arranged relative to the guide frame along the x-axis. This means that the compensation part cannot be moved relative to the guide frame from the home position along the x-axis.

An advantageous development provides that the at least one first linear guide and/or the at least one second linear guide each has/have at least one guide rail and at least one bearing rail. When being used for guidance, the guide rail and the bearing rail work together, with the guide rail and the bearing rail coming to rest against one another, in particular when being used for guidance.

Preferably, the at least one first linear guide has at least one bearing rail and one frame-side guide rail as well as one fastening-side guide rail. The frame-side guide rail is preferably arranged on the guide frame. The fastening-side guide rail is preferably arranged on the fastening part. The bearing rail is preferably arranged between the fastening-side guide rail and the frame-side guide rail. Alternatively, it is conceivable that the bearing rail is fixedly arranged on the fastening part or fixedly arranged on the guide frame. If the bearing rail is fixedly arranged on the fastening part, the fastening-side guide rail can be omitted. If the bearing rail is fixedly arranged on the guide frame, the frame-side guide rail can be omitted.

Preferably, the at least one second linear guide has at least one bearing rail and one frame-side guide rail as well as one compensation-side guide rail. The frame-side guide rail is preferably arranged on the guide frame. The compensation-side guide rail is preferably arranged on the compensation part. The bearing rail is preferably arranged between the compensation-side guide rail and the frame-side guide rail. Alternatively, it is conceivable that the bearing rail is fixedly arranged on the compensation part or fixedly arranged on the guide frame. If the bearing rail is fixedly arranged on the compensation part, the compensation-side guide rail can be omitted. If the bearing rail is fixedly arranged on the guide frame, the frame-side guide rail can be omitted.

It is advantageous if the at least one bearing rail, in particular the bearing rail of the first linear guide and/or the second linear guide, is designed as a rolling bearing guide, in particular as a crossed roller guide. The crosswise arrangement of the cylindrical rollers results in high rigidity and load-bearing capacity, which further improves the longevity of the compensation unit.

It is further advantageous if the at least one guide rail, in particular the fastening-side guide rail and/or the frame-side guide rail and/or the compensation-side guide rail, is designed as a V-shaped cross rail. In V-shaped cross rails, the rolling bearing guides, in particular the crossed roller guides, are surrounded on all four sides in the assembled state or come to rest on all four sides.

An advantageous development of the invention provides that the guide frame has a rectangular, in particular square, cross section along the z-axis that runs perpendicularly to the guide plane. Preferably, the guide frame has a central passage. The guide frame preferably has a frame top extending in parallel with the guide plane and a frame bottom extending in parallel with the guide plane and is opposite the frame top. The guide frame preferably has four short sides of the frame between the frame top and the frame bottom.

Advantageously, a guide rail, in particular a V-shaped cross rail, is arranged on each of the four short sides of the frame.

A further advantageous development provides that the compensation unit has a locking module for locking the compensation part and/or the guide frame in the home position. The locking module is preferably arranged in the fastening part, in particular in the housing of the fastening part. The locking module preferably has a centering bolt that can be moved along the z-axis between a release position and a locking position. In the locking position, the centering bolt cooperates with the compensation part and/or the guide frame so that movement of the compensation part and/or the guide frame from the home position is not possible. In the release position, the centering bolt does not engage with the compensation part and/or the guide frame so that the compensation part and/or the guide frame can be freely moved in the compensation direction into the compensation position. Preferably, the locking module extends through the central passage of the guide frame in the locking position and in particular also in the release position.

It is advantageous if the centering bolt has a first bevel, in particular a conical portion, at the first bolt end facing the compensation part. It is further advantageous if a second bevel, in particular a centering shell preferably accessible from the locking module, is arranged on the compensation part. Preferably, in the locking position, the first bevel and the second bevel cooperate in such a way that the compensation unit is pushed counter to the compensation direction, in particular is moved into the home position. Preferably, the second bevel, in particular the centering shell, extends through the central passage of the guide frame. The arrangement of the centering bolt and/or the centering shell in the central passage also allows for a flat design of the compensation part. The first bevel can be formed in one piece or in two pieces with the centering bolt. The second bevel can be formed in one piece or in two pieces with the compensation part.

An advantageous development of the invention provides that a locking piston is provided at a second end of the centering bolt that is opposite the first bolt end. The locking piston is preferably formed in one piece or in two pieces with the centering bolt. The locking piston is preferably arranged in a locking cylinder, wherein the locking piston in the locking cylinder delimits a pressurizable first pressure chamber and in particular also delimits a pressurizable second pressure chamber. The locking cylinder is preferably arranged in the fastening part, in particular in the housing of the fastening part. A pressure applied to the first pressure chamber acts on the centering bolt by means of the locking piston and pushes the centering bolt in the direction of the locking position, in particular into the locking position. A pressure applied to the second pressure chamber acts on the centering bolt by means of the locking piston and pushes the centering bolt in the direction of the release position, in particular into the release position. Alternatively, it is conceivable that a spring means, in the form of a compression extension spring, is provided for applying pressure to the first pressure chamber or the second pressure chamber in order to move the centering bolt into the locking position or the release position. The first pressure chamber and/or the second pressure chamber can preferably be fluidically connected to an external pressure supply by means of lines, in particular lines in the fastening part.

It is also advantageous if the centering bolt can be moved into an intermediate position between the release position and the locking position. This can limit the freedom of movement, i.e., the distance that the compensation part and/or guide frame can travel relative to the fastening part. The intermediate position can preferably be achieved by simultaneously pressurizing the first pressure chamber and the second pressure chamber.

A further advantageous development of the invention provides that the compensation unit has a fixing module for fixing the compensation part in the compensation position and/or home position. The fixing module can be provided in addition to or alternatively to the locking module. If both the fixing module and the locking module are provided, the locking module is used, among other things, to lock the compensation part and/or the guide frame in the home position and the fixing module is used to fix the compensation part and/or the guide frame in the compensation position. For example, when mounting a pin in a bore in a position with roughly tolerance, this means that a planar offset can thus be compensated for and then temporarily maintained.

It is advantageous if the fixing module is designed as at least one friction element that can be moved along the z-axis between a release position and a fixing position in order to fix the compensation part and/or the guide frame in the compensation position. The fixing module and/or the friction element can preferably be designed as an annular piston. In the fixing position, the fixing module cooperates with the compensation part and/or the guide frame, in particular by means of a frictional fit, so that the compensation part and/or the guide frame cannot move from the current compensation position or the home position. In the fixing position, the fixing module preferably comes to rest on the compensation part, in particular with the centering shell. In the release position, the fixing module does not engage with the compensation part and/or the guide frame so that the compensation part and/or the guide frame can move freely in the compensation direction into another compensation position or into the home position. Preferably, the fixing module extends through the central passage of the guide frame in the locking position and in particular also in the release position.

It is further advantageous if the fixing module, in particular the friction element and/or the annular piston, delimits at least one further pressurizable first pressure chamber and in particular one further pressurizable second pressure chamber. The further first pressure chamber and/or the further second pressure chamber is preferably arranged in the fastening part, in particular in the housing of the fastening part. A pressure applied to the further first pressure chamber acts on the fixing module and pushes the fixing module in the direction of the fixing position, in particular into the fixing position. A pressure applied to the further second pressure chamber acts on the fixing module and pushes the fixing module in the direction of the release position, in particular into the release position. The further first pressure chamber and/or the further second pressure chamber can preferably be fluidically connected to an external pressure supply by means of further lines, in particular lines in the fastening part. The first pressure chamber and/or the second pressure chamber and/or the further first pressure chamber and/or the further second pressure chamber can each be pressurized independently of one another. Alternatively, it is conceivable that a spring means, in the form of a compression or tension spring, is provided for applying pressure to the first pressure chamber or the second pressure chamber in order to move the fixing module into the fixing position or the release position.

It is also advantageous if the fixing module can be moved in an intermediate position between the release position and the fixing position. This allows the force required to move the compensation part and/or the guide frame to be adjusted. The intermediate position can preferably be created by simultaneously pressurizing the further first pressure chamber and the further second pressure chamber.

An advantageous development provides that the compensation unit has a sensor device with at least one for recording the position of the compensation part and/or the guide frame with at least one signal transmitter and at least one signal receiver. The sensor can be designed as at least one inductive sensor. In this case, the fastening part and/or the guide frame and/or the compensation part and/or one of the bearing rails and/or one of the guide rails, in particular the crossed roller cage, can be designed as a signal transmitter comprising an electrically conductive material. The sensor device can alternatively be designed as a magnetic field sensor. In this case, a permanent magnet can be arranged as a signal transmitter on the fastening part and/or on the guide frame and/or on the compensation part and/or on one of the bearing rails and/or on one of the guide rails, in particular on the crossed roller cage. In this case, a Hall sensor, for example, can be used as a signal receiver. The signal receiver can preferably be arranged in a sensor groove in the outside of the fastening part and/or the compensation part.

Preferably, one sensor is provided for detecting the position along the x-axis and one sensor is provided for detecting the position along the y-axis.

A further advantageous development provides that the compensation unit has a balancing apparatus for applying a force to the compensation part and/or the guide frame. A force can preferably be applied to the compensation part and/or the guide frame along the x-axis and/or along the y-axis. Thus, the compensation part and/or the guide frame can be moved to a defined compensation position. The balancing device preferably has a balancer for the x-axis and/or a balancer for the y-axis. The balancing device, in particular the at least one balancer, can preferably be detachably arranged on the outside of the fastening part and/or the compensation part. The balancer preferably has a follower which cooperates with a cam arranged on the fastening part and/or on the compensation part in such a way that the compensation part and/or the guide frame is/are moved from the home position into a compensation position, from the compensation position into the home position and/or from a first compensation position into a second compensation position and/or is/are held in the home position and/or the compensation position.

The invention further comprises a compensation unit having the features of the preamble of claim 1. The compensation unit has a guide frame formed in one piece, wherein at least one, preferably two, frame-side guide rails extending along the x-axis and at least one, preferably two, frame-side guide rails extending along the y-axis are arranged on the guide frame in one piece or in two pieces. The movement of the frame-side guide rails is preferably coupled with the movement of the guide frame. In accordance with the previously described embodiment, the frame-side guide rails preferably form the first linear guide and the second linear guide, together with guide rails arranged on the fastening part and on the compensation part and bearing rails arranged between each of the guide rails. Accordingly, by means of the guide frame and the frame-side guide rails extending along the x-axis and along the y-axis, it is possible for the compensation part to move relative to the fastening part from the home position into the compensation position. Accordingly, the frame-side guide rails arranged on the guide frame each form at least one guide partner of the first linear guide and at least one guide partner of the second linear guide. Due to the special design of the guide frame, the compensation part can be particularly flat.

The object addressed by the invention is likewise achieved by a system having the features of claim 19.

Further details and advantageous embodiments of the invention can be found in the following description, on the basis of which an exemplary embodiment of the invention is described and explained in more detail.

In the drawings:

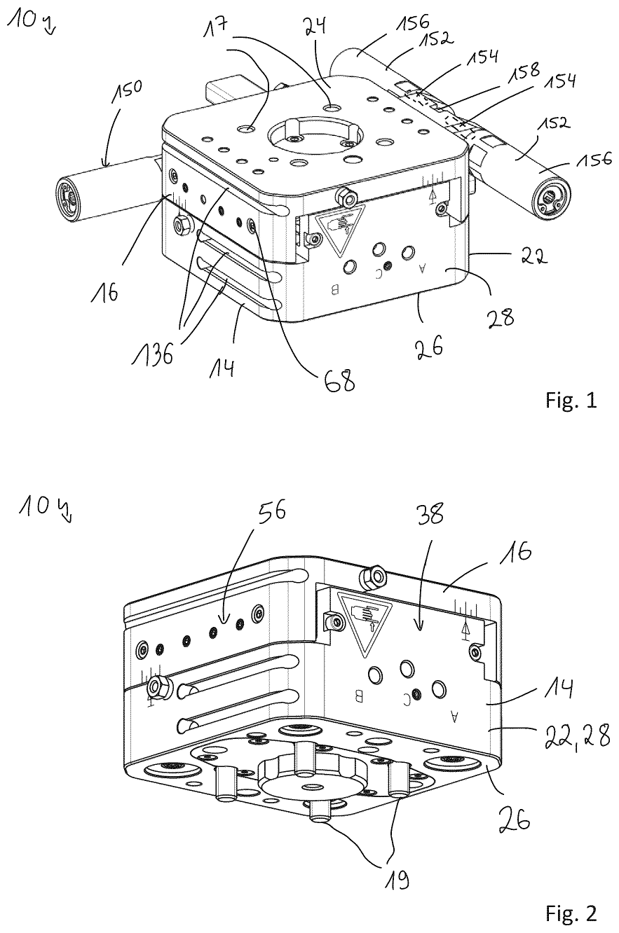

FIG. 1 is a perspective view from above of a compensation unit according to the invention;

FIG. 2 is a perspective view from below of the compensation unit according to FIG. 1;

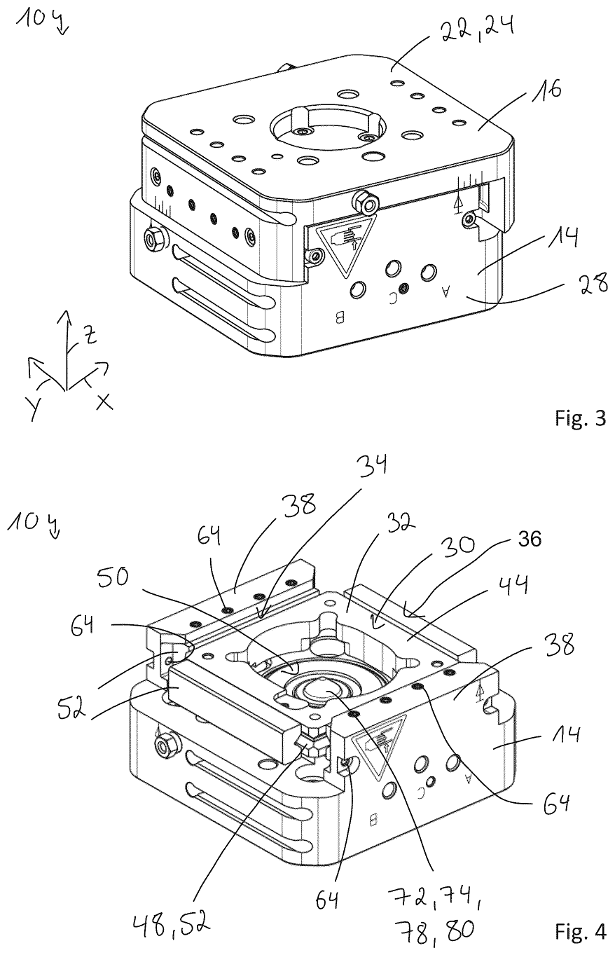

FIG. 3 is a perspective view from above of the compensation unit according to FIG. 1, wherein the compensation part is in the compensation position;

FIG. 4 is a perspective view of the compensation unit according to FIG. 1 without the compensation part;

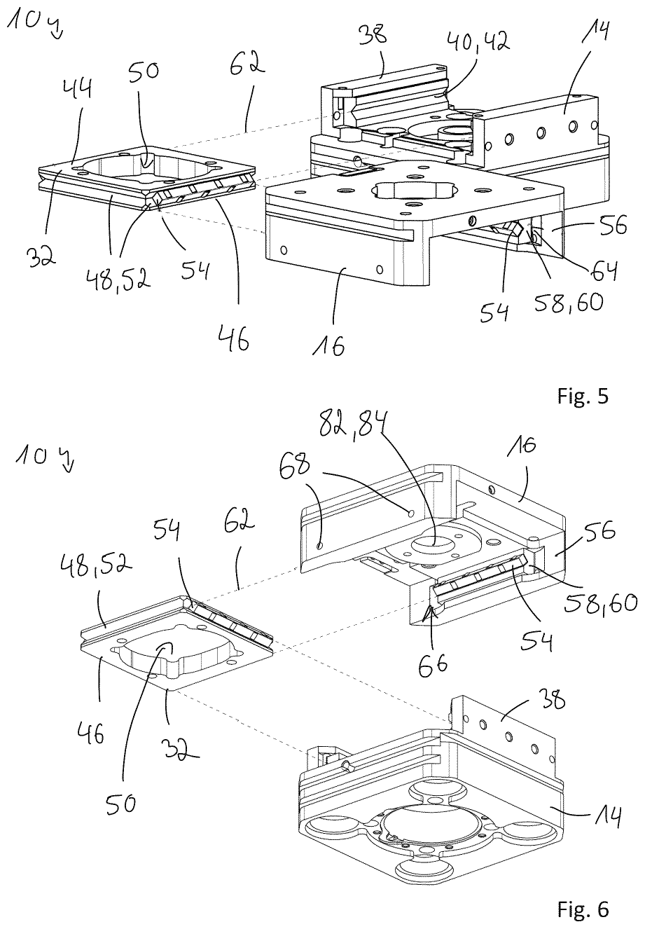

FIG. 5 is a schematic exploded view from above of the compensation unit according to FIG. 1;

FIG. 6 is a schematic exploded view from below of the compensation unit according to FIG. 1;

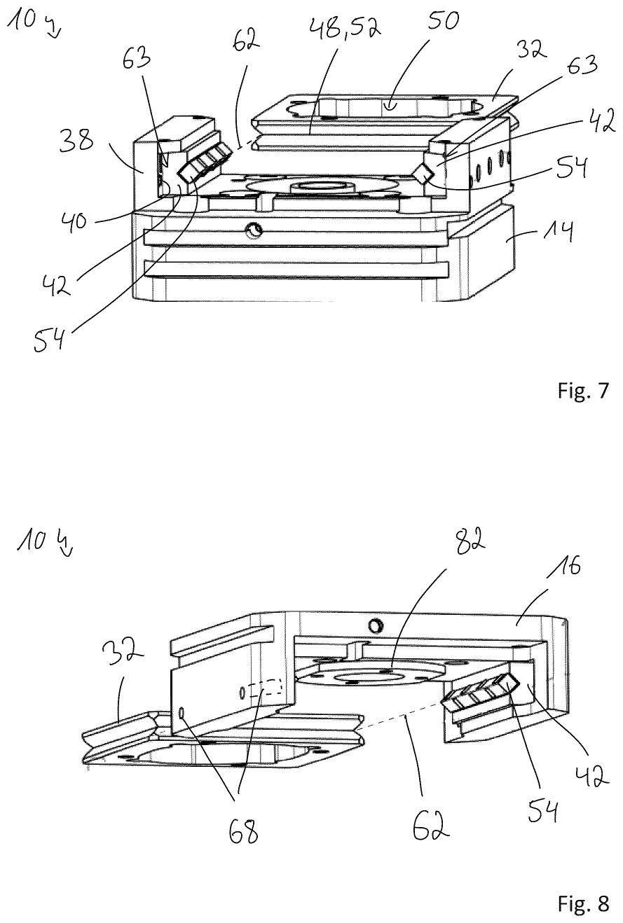

FIG. 7 is a schematic exploded view from above of the compensation unit according to FIG. 1 without the compensation unit;

FIG. 8 is a schematic exploded view from below of the compensation unit according to FIG. 1 without the fastening part;

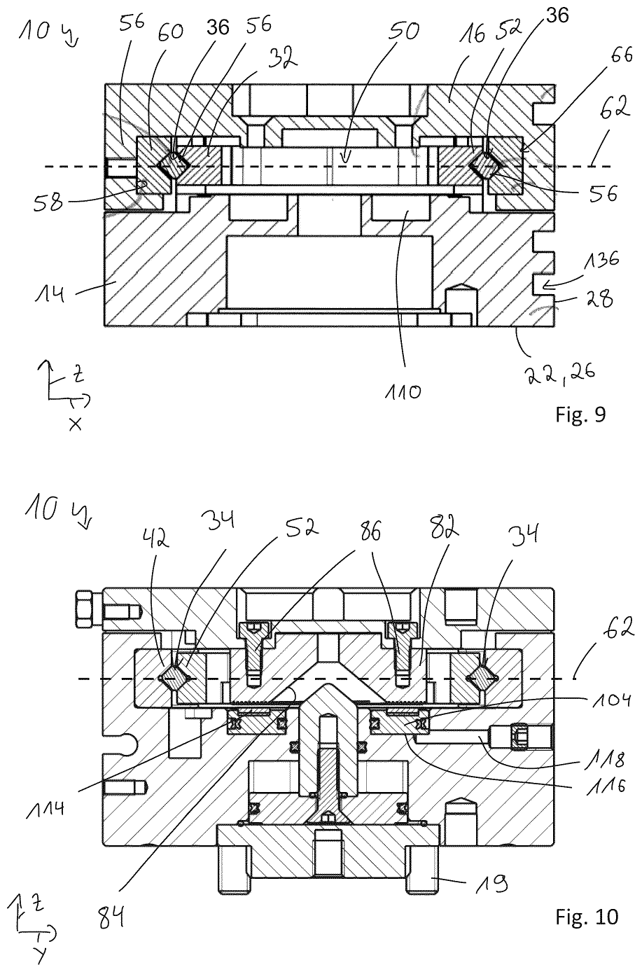

FIG. 9 is a schematic sectional view of the compensation unit according to FIG. 1 along the x-axis (A-A);

FIG. 10 is a schematic sectional view of the compensation unit according to FIG. 1 in parallel with the y-axis (C-C);

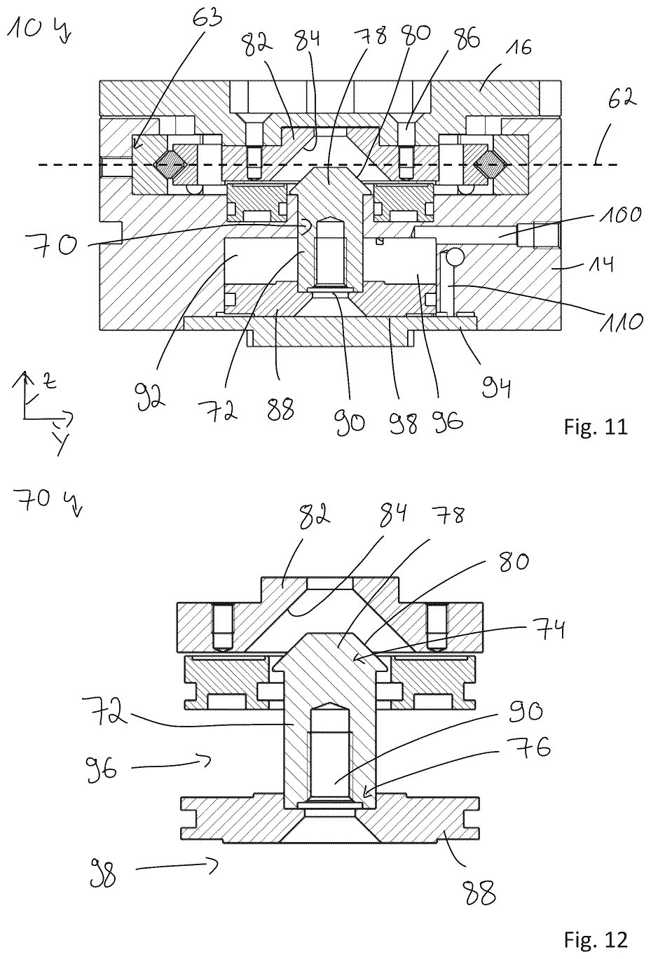

FIG. 11 is a further schematic sectional view of the compensation unit according to FIG. 1 along the y-axis (B-B), wherein the compensation part is in the home position;

FIG. 12 is a schematic sectional view of the locking module and the fixing module along the y-axis (B-B), wherein the compensation part is in the home position;

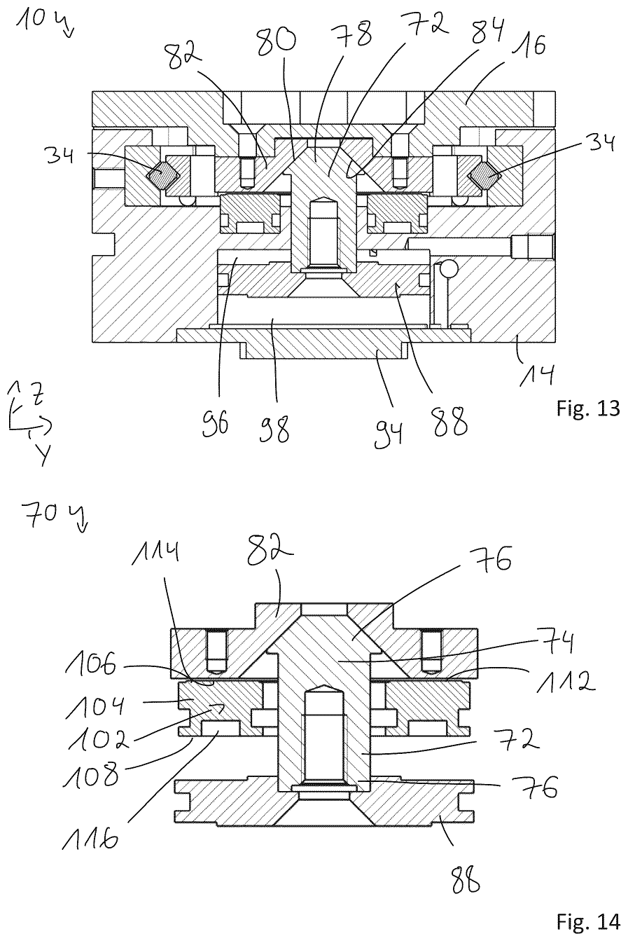

FIG. 13 is a schematic sectional view of the compensation unit according to FIG. 1 along the y-axis (B-B), wherein the centering bolt is in the locking position;

FIG. 14 is a schematic sectional view of the locking module and the fixing module along the y-axis (B-B), wherein the centering bolt is in the locking position;

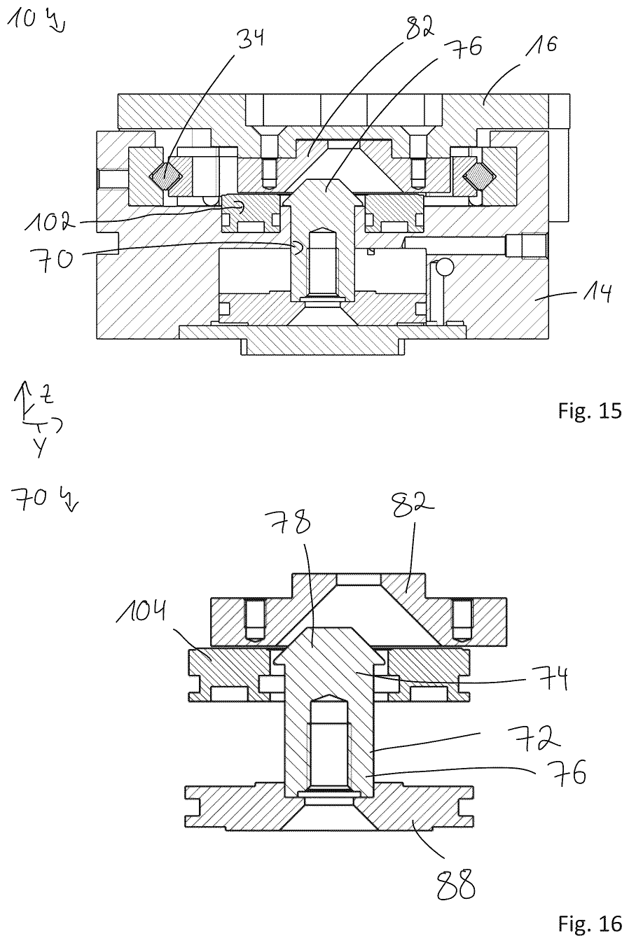

FIG. 15 is a schematic sectional view of the compensation unit according to FIG. 1 along the y-axis (B-B), wherein the compensation part is in the compensation position;

FIG. 16 is a schematic sectional view of the locking module and the fixing module along the y-axis (B-B), wherein the compensation part is in the compensation position;

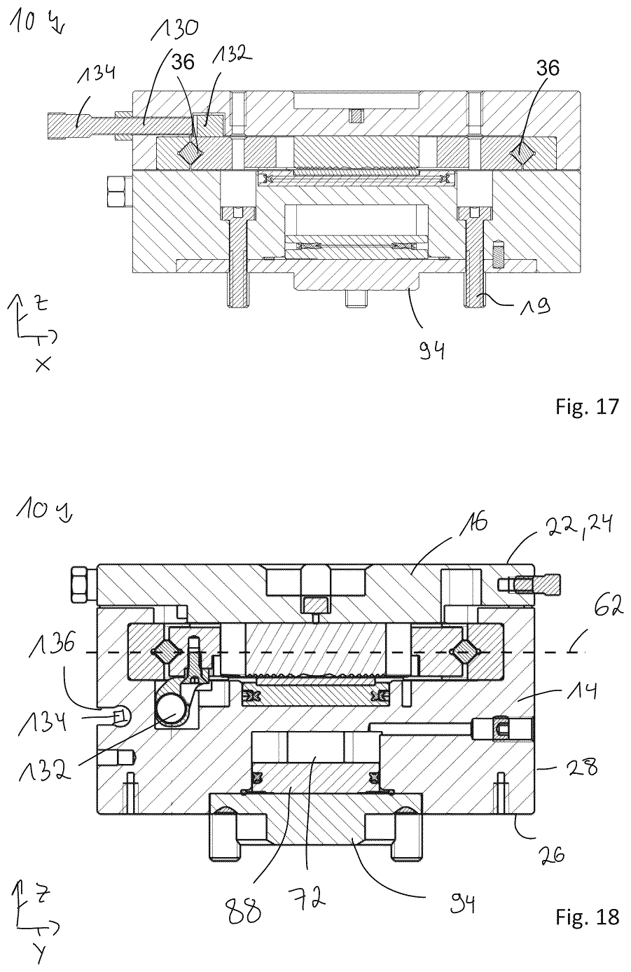

FIG. 17 is a schematic sectional view of another embodiment of the compensation unit along the x-axis (A-A) with an inductive sensor;

FIG. 18 is a schematic sectional view of another embodiment of the compensation unit along the y-axis (B-B) comprising a solenoid switch;

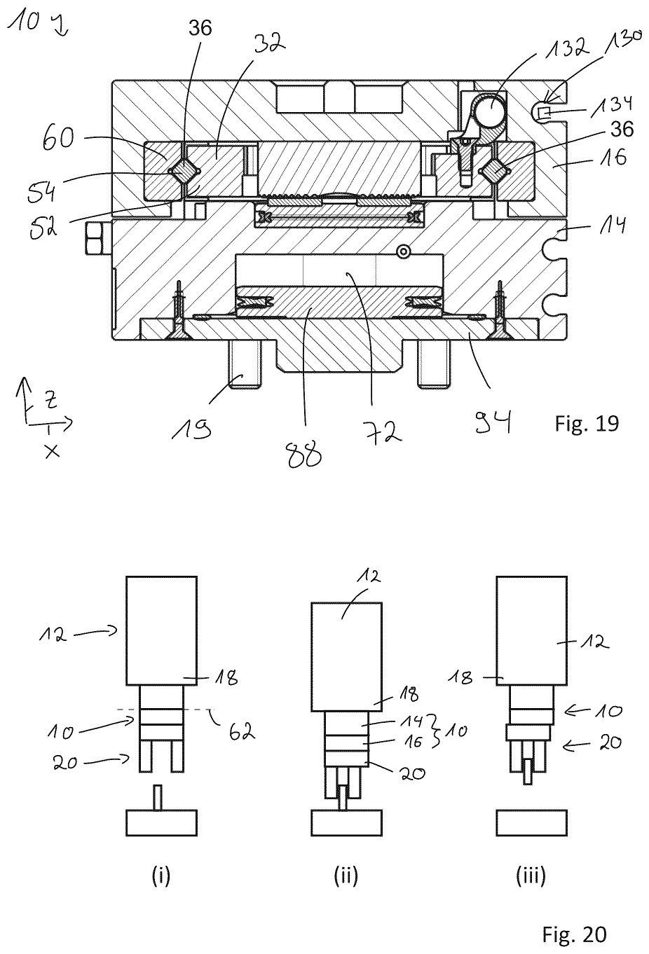

FIG. 19 is a schematic sectional view of the embodiment of the compensation unit according to FIG. 18 along the x-axis (A-A) comprising a solenoid switch; and

FIG. 20 is a schematic side view of a gripping process of a handling device comprising a compensation unit according to the invention and comprising a gripping tool.

In FIG. 20, a compensation unit 10 according to the invention is connected to a handling device 12 in the form of a robot arm. The compensation unit 10 has, according to FIG. 1-3, a fastening part 14 and a compensation part 16, wherein, according to FIG. 20, the fastening part 14 is arranged on a receiving flange 18 of the robot arm. For this purpose, according to FIGS. 2 and 6, the fastening part 14 has flange-side fastening means 19. The compensation part 16 has a tool flange (not shown) for connecting a gripping tool 20. According to FIGS. 1 and 3, the compensation part 16 can have threaded bores 17 for connecting said tool. The compensation part 16 is connected to the fastening part 14 such that it can move along an x-axis X and a y-axis Y so that a relative movement or compensation movement between the fastening part 14 and the compensation part 16 is possible. In FIG. 11 to 14, the compensation part 16 is arranged in the home position. In FIG. 15-16, the compensating part 16 is arranged in the compensation position. In the case illustrated in FIG. 20, the gripping tool 20 grips a pin which is arranged in a position with loose tolerance (i). Due to the planar offset, the gripping tool 20 grips the pin off-center (ii). The compensation unit 10 is designed such that the compensation part 16 performs a movement into a compensation position so that the pin is gripped centrally in the gripping tool 20 (iii). The compensation unit 10 can then fix the compensation part 16 in the compensation position (store in the intermediate position) or move it back to the home position.

According to FIG. 1-3, the fastening part 14 has a housing 22 with a housing top 24 facing the compensation part 16, with a housing bottom 26 facing away from the compensation part 16 and with a housing lateral surface 28 arranged between the housing top 24 and the housing bottom 26.

On the top 24, the housing 22 has, according to FIGS. 4, 5 and 7, a receptacle 30 for receiving the compensation part 16 and a guide frame 32. In the assembled state, the fastening part 14 and the compensating part 16 form an essentially closed unit. The guide frame 32 is arranged along the z-axis Z between the fastening part 14 and the compensating part 16. The guide frame 32 is arranged so as to be movable relative to the fastening part 14 along the x-axis in two first linear guides 34. The guide frame 32 is fixed relative to the fastening part 14 along the y-axis. The compensation part 16 is arranged so as to be movable relative to the guide frame 32 along the y-axis in two second linear guides 36. The compensating part 16 is fixed relative to the guide frame 32 along the x-axis. Overall, the compensation part 16 can be moved along both the x-axis and the y-axis from the home position into a compensation position by means of the guide frame 32.

According to FIGS. 4, 5 and 7, the housing 22 has two fastening-side guide portions 38 on the top 24 that protrude in parallel with the z-axis, wherein a fastening-side guide rail 42 is arranged in the interior 40 of the fastening-side portion in each case.

According to FIG. 4-6, the guide frame 32 has a square cross section along the z-axis with a frame top 44, a frame bottom 46, four short sides 48 of the frame arranged between the frame top 44 and the frame bottom 46 and a central passage 50.

According to FIGS. 5 and 6, the guide frame 32 has a frame-side guide rail 52 on each of the four short sides 48 of the frame. In the assembled state, the guide frame 32 is inserted into the receptacle 30, wherein a bearing rail 54 is arranged between the fastening-side guide rail 42 and the frame-side guide rail 52. The fastening-side guide rail 42, the frame-side guide rail 52 and the bearing rail 54 form one of the two first linear guides 34. The first linear guides 34 are identically designed. By means of the first linear guides 34, the guide frame 32 is arranged so as to be movable relative to the fastening part 14 along the x-axis.

According to FIGS. 5, 6 and 8, the compensation part 16 has two compensation-side guide portions 56 which project in parallel with the z-axis and face the fastening part 14, wherein a compensation-side guide rail 60 is arranged in the interior 58 of each compensation-side portion.

According to FIG. 1-3, the compensation-side guide portions 56 form end stops of the compensation part 16, which contact the fastening-side guide portions 38 during movement into the maximum compensation position.

According to FIGS. 4, 6 and 8, a further bearing rail 54 is arranged between the two remaining frame-side guide rails 52 arranged on the guide frame 32 and the compensation-side guide rails 60 in each case. The frame-side guide rail 52, the compensation-side guide rail 60 and the bearing rail 54 form one of the two second linear guides 34. The second linear guides 34 are identical to one another and/or to the first linear guides. By means of the second linear guides 36, the compensation part 16 is arranged so as to be movable relative to the guide frame 32 along the y-axis.

The fastening part 14, the guide frame 32 and the compensation part 16 are designed, according to FIG. 4-6, such that the two first linear guides 34 and the two second linear guides 36 are arranged in a common guide plane 62 running perpendicularly to the z-axis. Accordingly, the compensation unit 10 can be particularly flat. In addition, the lever arm between the center of gravity of the compensation part 16, in particular with the tool 20 and any workpieces that may be arranged thereon, and the first linear guides 34 or the second linear guides 36 is identical so as to provide a uniform load and thus a compensation unit 10 with a longer service life.

According to FIG. 5-7, the fastening-side guide rails 42 are formed in two pieces with the fastening part 14 and each arranged in the interior 40 of the fastening-side portion in a fastening-side guide groove 63. According to FIGS. 4 and 7, the fastening-side guide rails 42 are fixed in the fastening-side guide groove 63 by means of fastening-side fastening means 64 extending in parallel with the z-axis. According to FIGS. 6 and 8, the compensation-side guide rails 60 are formed in two pieces with the compensation part 16 and each arranged in the interior 58 of the compensation-side portion in a compensation-side guide groove 66. The compensation-side guide rails 60 are fixed in the compensation-side guide groove 66 by means of compensation-side fastening means 68 extending in parallel with the z-axis. The frame-side guide rails 52 are also formed in one piece with the guide frame 32. The bearing rails 54 of the first guide 34 are also detachably arranged on the fastening part 14 by means of fastening-side fastening means 64. The bearing rails 54 of the second guide 34 are detachably arranged on the compensation part 16 by means of compensation-side fastening means 68. The fastening means 64 and 68 preferably serve as stops for the guide rails 42, 52, 60 so that they cannot fall or shift out of the guide grooves 63, 66.

The guide rails 42, 52, 60 are preferably designed as V-shaped cross rails according to FIG. 5-11. The bearing rails 54 are preferably designed as crossed roller guides. In the assembled state, the bearing rails 54 are received by the adjacent guide rails 42, 52, 60.

To lock the compensation part 16 in the home position and/or to limit the compensation travel of the compensation part 16, a locking module 70 is provided in the fastening part 14 according to FIG. 10-16. The locking module 70 has a circular-cylindrical centering bolt 72 extending along the z-axis with a first upper bolt end 74 facing the compensation part 16 and a second lower bolt end 76 facing away from the compensation part 16. The centering bolt 72 is movable along the z-axis between a lower release position in which the compensation part 16 is freely movable, and an upper locking position in which the compensation part 16 is locked in the home position. In FIG. 10-12 and FIG. 15-16, the centering bolt 72 is arranged in the release position. In FIG. 13-14, the centering bolt 72 is arranged in the locking position. The centering bolt 72 has a conical portion 78 comprising at least one first bevel 80 at its first bolt end 74. In the locking position, the conical portion 78 cooperates with a centering shell 82 arranged on the compensation part 16 that comprises a second bevel 84. When the centering bolt 72 is moved in the direction of the locking position, the first bevel 80 and the second bevel 84 cooperate in such a way that the closer the centering bolt 72 is to the locking position, the closer to the home position the compensation part 16 is pushed. As soon as the centering bolt 72 is in the locking position, the compensation part 16 is also fixed in the home position. To release the compensation part 16, the centering bolt 72 is moved into the release position. It is also conceivable that the centering bolt 72 is arranged in an intermediate position, in which the compensation part 16 is movable into a compensation position but the movement path is limited by the centering bolt 72.

According to FIGS. 11, 13 and 15, the centering shell 82 is formed in two pieces with the compensation part 16. The centering shell 82 is detachably fastened to the compensation part 16 by means of fastening-side retaining means 86 in the form of countersunk screws and/or cheese head screws running perpendicularly to the z-axis. Alternatively, it is conceivable that the compensation part 16 and the centering shell 82 are formed in one piece. The centering shell 82 is arranged centrally relative to the compensating part 16. The centering shell 82 is arranged along the z-axis between the fastening part 14, in particular the centering bolt 72, and the compensating part 16.

In the assembled state, according to FIGS. 11, 13 and 15, the centering shell 82 extends into the central passage 50 of the guide frame 32, allowing for a flat construction of the compensation unit 10. Along the y-axis, the centering shell 82 is arranged between the first linear guides 34 and/or, along the x-axis, said centering shell is arranged between the second linear guides 36. In the release position, the centering bolt 72 extends through some of the central passage 50 of the guide frame 32, and in the locking position, said centering bolt extends through the entire central passage.

The centering bolt 72 has a locking piston 88 at its second bolt end 76 as shown in FIG. 11-16. The locking piston 88 is formed in two pieces with the centering bolt 72. The locking piston 88 is detachably fastened to the centering bolt 72 by means of piston-side fastening means 90.

According to FIG. 11-16, the interior of the fastening part 14 has a locking cylinder 92 comprising an oval cavity, the oval shape being particularly evident in FIG. 2. The locking cylinder can also have a circular cylindrical cavity. The locking cylinder 92 is closed by means of a housing cover 94 on the housing bottom 26, wherein the housing cover 94 is fixed to the fastening part 14 by means of screws extending in parallel with the z-axis.

According to FIG. 11-16, the locking piston 88 delimits a lower first pressure chamber 96 at the bottom by means of the locking cylinder 92 and the housing cover 94. The locking piston 88 defines an upper second pressure chamber 98 at the top by means of the locking cylinder 92. The locking piston 88 has a seal (not shown) on the lateral surface in order to fluidically separate the first pressure chamber 96 and the second pressure chamber 96. The first pressure chamber 96 and the second pressure chamber 98 are each fluidically connected to lines 100, wherein the first pressure chamber 96 and the second pressure chamber 98 can be pressurized separately by means of the lines 100. The lines 100 open into the housing lateral surface 28 and/or into the housing bottom 26. When the first pressure chamber 96 is pressurized, the locking piston 88 and thus also the centering bolt 72 are pushed upward into the locking position so that the compensation part 16 is locked in the home position. When the second pressure chamber 98 is pressurized, the locking piston 88 and thus also the centering bolt 72 are pushed downward into the release position so that the compensation part 16 is released.

Furthermore, the compensation unit 10 according to FIG. 10-16 has a fixing module 102 for fixing the compensation part 16 in the compensation position and/or in the home position. The fixing module 102 has an annular piston 104 arranged centrally around the z-axis with respect to the fastening part 14, wherein the annular piston 104 is movable along the z-axis between a lower release position and an upper fixing position. The annular piston 104 has a ring top 106 facing the compensation part 16 and a ring bottom 108 facing away from the compensation part 16. To accommodate the annular piston 104, the fastening part 14 has a ring receptacle 110 according to FIG. 6. On the ring top 106, the annular piston 104 has a friction element 112 which, in the fixing position, cooperates with a friction portion 114 of the compensation part 16, in particular the centering shell 82, such that the compensation part 16 is fixed in the current compensation position and/or home position. The friction portion 114 may preferably have a surface that is roughened with respect to the remaining surfaces. The friction element 112 can be formed in two pieces with the annular piston 104 as a wearing part. The annular piston 104 defines a first further pressure chamber 116 on the ring bottom 108 with the ring receptacle 110. The first further pressure chamber 116 can be pressurized by means of further lines 118 as shown in FIG. 10. The further lines 118 open into the housing lateral surface 28 and/or the housing bottom 26. When the first additional pressure chamber 116 is pressurized, the annular piston 104 is pushed into the fixing position. In order to move the annular piston 104 into the release position, a second additional pressure chamber (not shown) can be pressurized or spring-loaded return means (not shown), such as at least one return spring, can be provided.

However, it is also conceivable that no means are provided for moving the annular piston into the release position. The annular piston 104 has a seal (not shown) on the lateral surface for fluidically separating the first further pressure chamber 116 from the surroundings.

Furthermore, the compensation unit 10 in the second and third embodiments according to FIG. 17 and 18-19 has a sensor apparatus 130 for recording the position of the compensation part 16 and/or the guide frame 32 and/or the centering bolt 72 and/or the annular piston 104. The compensation part 16 and/or the guide frame 32 and/or the centering bolt 72 and/or the annular piston 104 can function as an active or passive signal transmitter 132. Alternatively or additionally, a permanent magnet, for example, can be arranged on the compensation part 16 and/or on the guide frame 32 and/or on the centering bolt 72 and/or on the annular piston 104 and function as a signal transmitter 132. Furthermore, at least one signal receiver 134 can be provided for detecting the signal of the at least one signal transmitter 132. According to FIG. 1 to 8, the fastening part 14 and/or the compensation part 16 have sensor grooves 136, wherein the signal receivers 134 can be arranged in the sensor grooves 136.

In FIG. 17, the compensation unit 10 has an inductive sensor as a signal receiver 134 on the compensation part 16. For this purpose, the compensation part 16 has sensor receptacles into which the signal receivers 134 are inserted. A metal sensor is provided on the guide frame 32 as a signal transmitter 132, which, in the assembled state, is received by a recess in the Compensation part 16.

In FIG. 18-19, the compensation unit 10 has a first solenoid switch as a signal receiver 134 for recording the position along the y-axis on the fastening part 14 and a second solenoid switch for recording the position along the x-axis on the compensation part 16, wherein the solenoid switches are each arranged in sensor grooves 136 in the outside of the housing. A magnet is provided as a signal transmitter 132, which is fastened to the guide frame 32 by means of screws running along the z-axis. The magnet according to FIG. 18 for the y-axis extends downward along the z-axis away from the guide frame 32, in particular the frame bottom 46, wherein a recess for receiving the magnet is provided in the fastening part 14. The magnet according to FIG. 19 for the x-axis extends upward along the z-axis away from the guide frame 32, in particular the frame top 44, wherein a recess for receiving the magnet is provided in the compensation part 16.

Furthermore, the compensation unit 10 according to FIGS. 1 and 2 has a balancing apparatus 150 for actively moving the compensation part 16 and/or the guide frame 32. Accordingly, the compensation part 16 can also be moved into a compensation position without any external intervention. The balancing apparatus 150 has at least one balancer 152 comprising a follower 154 for each of the x-axis and the y-axis. The follower 154 can be moved along the x-axis or the y-axis by means of a balancer drive 156, preferably a spring cartridge. The follower 154 cooperates with a cam 158 so that the compensation part 16 can be moved. Preferably, the balancer 152 is arranged on the fastening part 14, in particular on the housing lateral surface 28, and the cam 158 is arranged on the compensation part 16. The balancers 152 are stacked along the z-axis. It is conceivable that the balancers 152 are arranged in a common plane, in particular one that is parallel to the guide plane 62, preferably in the guide plane 62.

Alternatively, it is conceivable that only the followers 154 and/or only the cams 158 are arranged in the guide plane 62.

### LIST OF REFERENCE SIGNS

X X-axis
Y Y-axis
Z Z-axis
10 Compensation unit
12 Handling device
14 Fastening part
16 Compensation part
17 Threaded bores
18 Receiving flange
19 Flange-side fastening means
20 Gripping tool
22 Housing
24 Housing top
26 Housing bottom
28 Housing lateral surface
30 Receptacle
32 Guide frame
34 First linear guides
36 Second linear guides
38 Fastening-side guide portion
40 Interior of the fastening-side portion
42 Fastening-side guide rail
44 Frame top
46 Frame bottom
48 Short sides of the frame
50 Passage
52 Frame-side guide rail
54 Bearing rail
56 Compensation-side guide portion
58 Interior of the compensation-side portion
60 Compensation-side guide rail
62 Guide plane
63 Fastening-side guide groove
64 Fastening-side fastening means
66 Compensation-side guide groove
68 Compensation-side fastening means
70 Locking module
72 Centering bolts
74 First bolt end
76 Second bolt end
78 Conical portion
80 First bevel
82 Centering shell
84 Second bevel
86 Fastening-side retaining means
88 Locking piston
90 Piston-side fastening means
92 Locking cylinder
94 Housing cover
96 First pressure chamber
98 Second pressure chamber
100 Lines
102 Fixing module
104 Annular piston
106 Ring top
108 Ring bottom
110 Ring receptacle
112 Friction element
114 Friction portion
116 Additional pressure chamber
118 Additional lines
130 Sensor apparatus
132 Signal transmitter
134 Signal receiver
136 Sensor groove
150 Balancing apparatus
152 Balancer
154 Follower
156 Balancer drive
158 Cam

1-18. (canceled)

19. A compensation unit for an automation plant, configured for arrangement between a handling device and a tool, comprising:
a fastening part;
a compensation part movable along an x-axis and along a y-axis extending perpendicularly to the x-axis, relative to the fastening part from a home position to a compensation position;
a guide frame positioned between the fastening part and the compensation part;
at least one first linear guide extending along the x-axis; and
at least one second linear guide extending along the y-axis,
wherein the first and second linear guides are arranged in a common guide plane,
wherein the first linear guide guides the guide frame relative to the fastening part,
wherein the second linear guide guides the compensation part relative to the guide frame,
wherein the guide frame includes a frame top and a frame bottom extending parallel to the guide plane and opposite each other, and four frame short sides arranged between the frame top and the frame bottom,
and wherein a frame-side guide rail of the linear guides is arranged on each of the four short sides of the guide frame.

20. The compensation unit of claim 19, wherein the guide frame is arranged between the fastening part and the compensation part along a z-axis perpendicular to the guide plane.

21. The compensation unit of claim 19, wherein lever arms between a center of gravity of the compensation part and each of the first and second linear guides are substantially identical to provide uniform loading and increased service life.

22. The compensation unit of claim 19, wherein the guide frame is movable relative to the fastening part along the x-axis.

23. The compensation unit of claim 19, wherein the compensation part is movable relative to the guide frame along the y-axis.

24. The compensation unit of claim 19, wherein each of the first and second linear guides includes at least one guide rail and at least one bearing rail.

25. The compensation unit of claim 24, wherein the first linear guide includes a bearing rail, a frame-side guide rail, and a fastening-side guide rail, the fastening-side guide rail being arranged on the fastening part, the frame-side guide rail being arranged on the guide frame, and the bearing rail being arranged between the fastening-side guide rail and the frame-side guide rail.

26. The compensation unit of claim 24, wherein the second linear guide includes a bearing rail, a frame-side guide rail, and a compensation-side guide rail, the compensation-side guide rail being arranged on the compensation part, the frame-side guide rail being arranged on the guide frame, and the bearing rail being arranged between the compensation-side guide rail and the frame-side guide rail.

27. The compensation unit of claim 24, wherein the bearing rail is configured as a crossed roller guide.

28. The compensation unit of claim 24, wherein the guide rail has a V-shaped cross section.

29. The compensation unit of claim 19, wherein the guide frame has a rectangular cross section along a z-axis extending perpendicularly to the guide plane, and defines a central passage.

30. The compensation unit of claim 19, further comprising a locking module configured to lock the compensation part in the home position, the locking module including a centering bolt movable along the z-axis between a release position and a locking position.

31. The compensation unit of claim 30, wherein the centering bolt includes a first bevel, and the compensation part includes a second bevel that cooperates with the first bevel in the locking position to move the compensation unit into the home position.

32. The compensation unit of claim 30, wherein a locking piston is arranged on the centering bolt and defines at least one pressurizable pressure chamber.

33. The compensation unit of claim 19, further comprising a fixing module configured to fix the compensation part in the compensation position.

34. The compensation unit of claim 33, wherein the fixing module comprises an annular piston movable along the z-axis between a release position and a fixing position.

35. The compensation unit of claim 33, wherein the fixing module defines at least one pressurizable pressure chamber.

36. The compensation unit of claim 19, further comprising a sensor device configured to detect a position of the compensation part, the sensor device including a signal transmitter and a signal receiver.

37. A system comprising:
a handling device;
a compensation unit according to claim 19; and
a tool arranged on the compensation unit.
